(19) United States
(12) Patent Application Publication
(10) Pub. No.: US 2008/0287166 A1
(43) Pub. Date: Nov. 20, 2008

(54) PORTABLE BLUETOOTH SPEAKER

(76) Inventor: PI-FEN LIN, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/748,794

(22) Filed: May 15, 2007

(51) Int. Cl. H04M 1/00

(52) U.S. Cl. 455/569.1

(57) ABSTRACT

A portable Bluetooth speaker includes a Bluetooth module for communicating wirelessly with a Bluetooth communication device and outputting a voice signal, a voice switching module connected with the Bluetooth module for receiving the voice signal, a speaker connected with the Bluetooth module, a wire-receiving unit having a wire slot, a wire-rolling disk, a communication wire, a volute spring, and a judging unit connected with the voice switching module and the wire-receiving unit. Due to the volute spring, the communication wire can be extended or received. One end of the communication wire is connected with the voice switching module. The second end of the communication wire is connected with the earphone. The judging unit outputs a judging signal to the voice switching module for switching the voice signal according to the communication wire being extended or received.

### BACKGROUND OF THE INVENTION

1. Field of the Invention

The present invention relates to a portable Bluetooth speaker. In particular, this invention relates to a portable Bluetooth speaker that can communicate with a Bluetooth cell phone and can operate in a speaker mode and in a wired earphone mode without the user having to hold the receiver.

2. Description of the Related Art

Bluetooth is a wireless communication technology that is cheap, uses little power, operates well over short distances, and can be applied to personal portable communication devices. By utilizing the wireless transmission functions of Bluetooth technology, Bluetooth earphones, portable cell phone watches and communicators directly worn on a user's body have been developed. These products include a Bluetooth chip so that they can perform a wireless transmission, link to the Internet, and receive e-mails.

There a variety of Bluetooth earphones that can cooperate with a Bluetooth cell phone. The user wears the Bluetooth earphone on his head to communicate with the Bluetooth cell phone in two directions at a standard frequency period. The user can utilize the wireless transmission function of Bluetooth technology to receive a call anytime, anywhere, without holding the receiver.

Reference is made to FIG. 1, which shows a schematic diagram of the communication structure between the Bluetooth earphone and the Bluetooth cell phone of the prior art. By using Bluetooth communication technology, the incoming call voice signal 50 of the Bluetooth cell phone 60 is transmitted to the Bluetooth earphone 40 in a wireless way, and the Bluetooth earphone 40 transmits a transmitted voice signal 52 to the Bluetooth cell phone 60. Thereby, the voice signal is transmitted in two directions, and the user can receive the incoming call anywhere, without holding the receiver.

Reference is made to FIGS. 1 and 2. FIG. 2 shows a block diagram of the circuit in the Bluetooth earphone of the prior art. When an incoming call is received, the wireless communication unit 401 of the Bluetooth earphone 40 receives the voice signal 50 of the incoming call from a remote Bluetooth cell phone 60. The voice signal 50 is transmitted to a controller 402 and is processed. After the voice signal 50 is processed by the controller 402, the voice signal 50 is emitted from the earphone 404 so that the user hears it clearly.

Similarly, the user can use the microphone 403 to transmit their responding voice signal 52 into the controller 402. The responding voice signal 52 is processed by the controller 402 and is transmitted to the wireless communication unit 401. By utilizing the wireless communication unit 401, the responding voice signal 52 is transmitted to the remote Bluetooth cell phone 60. The voice signal can be transmitted in two directions, and the user can receive the incoming call anywhere, without holding the receiver.

However, when the user wears the Bluetooth earphone 40 for a long time, the user may begin to feel uncomfortable. Furthermore, when a call is incoming, the Bluetooth earphone 40 only lets one user receive it. A third person cannot participate in the call. This is inconvenient for users who wish to have more than two people participate in a phone conversation using Bluetooth technology.

Therefore, a portable Bluetooth speaker that can perform wireless communication with the Bluetooth cell phone 60 is necessary for a user that needs to wear the Bluetooth earphone 40 for a long time. Furthermore, if the earphone, which is integrated with the portable Bluetooth speaker, allows the user to communicate in private with the person whom they are talking to on the phone, the communication quality will be improved. The user can select a proper communication mode according to the communication contents.

### SUMMARY OF THE INVENTION

One particular aspect of the present invention is to provide a portable Bluetooth speaker. It can communicate with a Bluetooth communication device in a wireless way, and can be operated in speaker mode or in an earphone mode without the user having to hold the receiver.

The portable Bluetooth speaker includes a Bluetooth module, a microphone, a voice switching module, a speaker, a wire-receiving unit, an earphone, and a judging unit. The Bluetooth module uses wireless communication technology to obtain a wireless signal from the Bluetooth communication device, and output a voice signal. The microphone is connected with the Bluetooth module. The voice switching module is connected with the Bluetooth module for receiving the voice signal. The speaker is connected with the voice switching module.

The wire-receiving unit includes a wire slot, a wire-rolling disk, a communication wire, and a volute spring. The wire-rolling disk and the volute spring are pivoted in the wire slot. The communication wire is rolled on the wire-rolling disk. Due the volute spring, the communication wire can be extended or received. One end of the communication wire is connected with the voice switching module. The earphone is connected with the second end of the communication wire. The judging unit is connected with the voice switching module and the wire-receiving unit. The judging unit outputs a judging signal to the voice switching module for switching the voice signal according to the communication wire being extended or received.

The present invention uses the speaker to amplify the voice signal outputted from the Bluetooth communication device so that a number of people can hear it clearly. The voice signal is amplified, and the user does not need to hold the receiver. Furthermore, the user can pull the earphone to extend the length of the wire that is exposed from the wire-receiving unit. With the earphone and wire then withdrawn to a suitable length, and the user may make a call using the earphone to hear the voice signals in private. The user does not need to hold the receiver.

Thereby, a third person can participate in the call. The communication quality is improved. The conversation can remain private and not be overheard by a third party.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the communication structure between the Bluetooth earphone and the Bluetooth cell phone of the prior art;

FIG. 2 is a block diagram of the circuit in the Bluetooth earphone of the prior art;

FIG. 3 is a schematic diagram of the communication structure of the present invention;

FIG. 4 is another schematic diagram of the communication structure of the present invention;

FIG. 5 is a schematic diagram of the operating status of the first embodiment of the present invention;

FIG. 6A is a schematic diagram of the operating status of the second embodiment of the present invention;

FIG. 6B is a schematic diagram of the operating status of the third embodiment of the present invention;

FIG. 7 is a block diagram of the circuit of the present invention;

FIG. 8 is a schematic diagram of the wire-receiving unit of the present invention; and

FIG. 9 is a schematic diagram of the circuit of the judging unit and the voice switching module of the present invention.

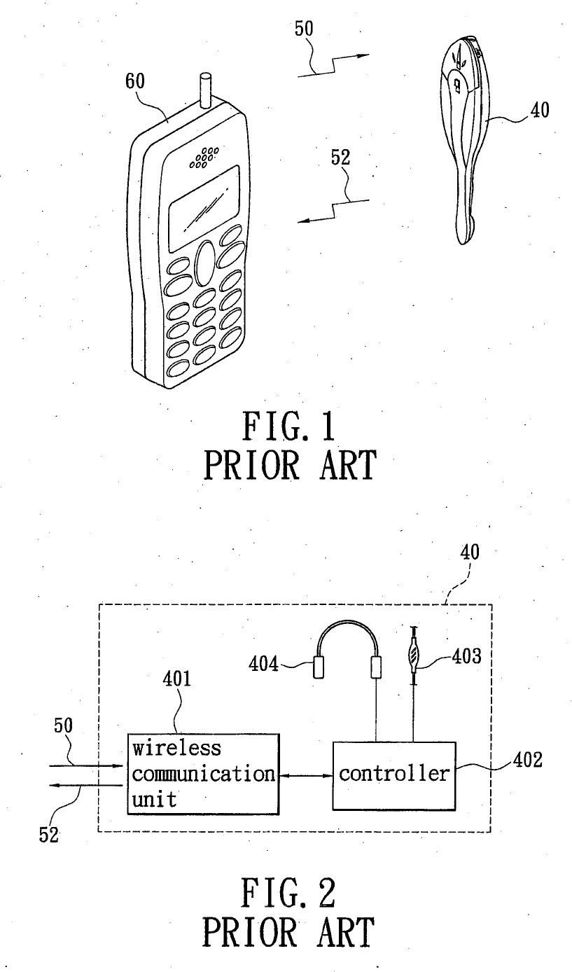

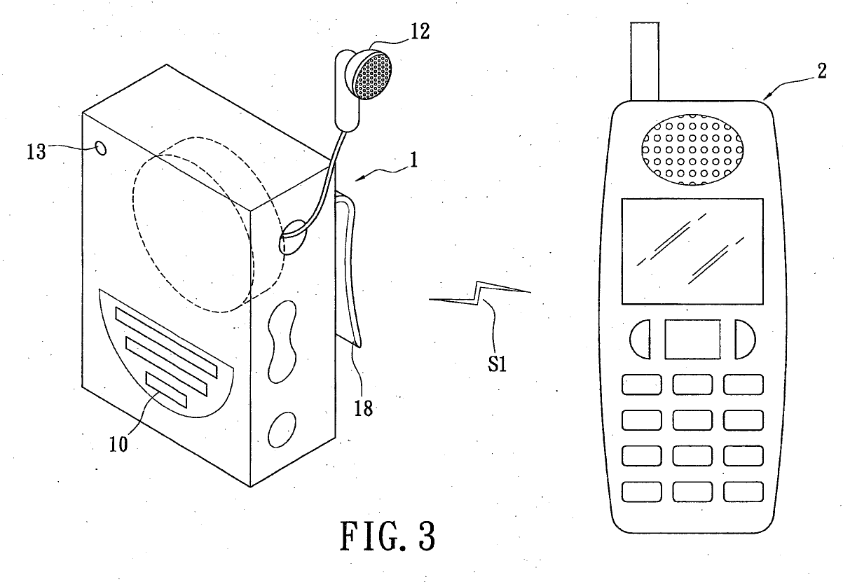

### DETAILED DESCRIPTION OF THE PREFERRED EMBODIMENTS

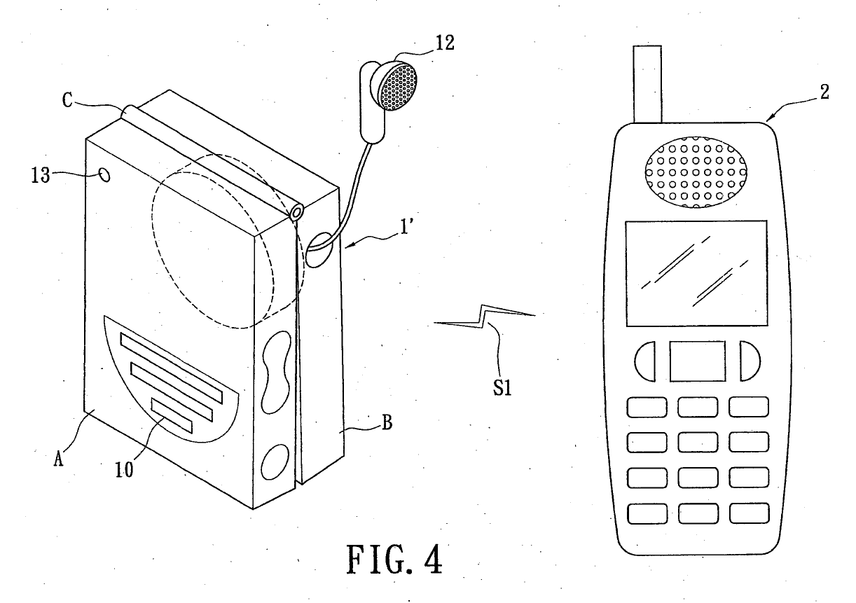

Reference is made to FIG. 3, which shows a schematic diagram of the communication structure of the present invention. The portable Bluetooth speaker 1 has a fixture 18 that fastens the portable Bluetooth speaker 1 on to a piece of clothing or similar article, and can perform wireless communication with a Bluetooth communication device 2. The Bluetooth communication device 2 can be a Bluetooth cell phone.

When a call is received by the Bluetooth communication device 2, a wireless signal SI is outputted to the Bluetooth speaker 1. After the Bluetooth speaker 1 processes the wireless signal SI, the Bluetooth speaker 1 cooperates with the speaker unit 10 and the microphone 13 to provide a speaker communication mode in which it is unnecessary for the user to hold the receiver. Alternatively, the earphone 12 attached via the wire to the speaker is withdrawn the Bluetooth speaker 1 cooperates with the microphone 13 to provide an earphone communication mode in which it is unnecessary for the user to hold the receiver.

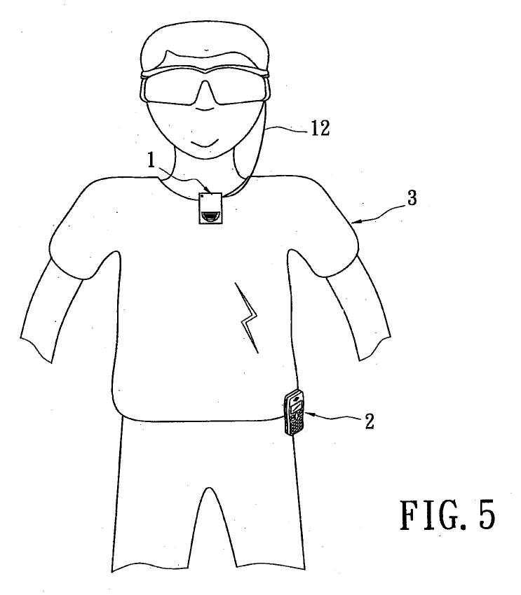

Reference is made to FIG. 4, which shows another schematic diagram of the communication structure of the present invention. The structure of the portable Bluetooth speaker 1′ is different from that of the portable Bluetooth speaker 1 as shown in FIG. 3. The portable Bluetooth speaker 1′ is composed of a speaker body A, an earphone body B, and a pivoting shaft base C. The pivoting shaft base C is installed on one end of the speaker body A. The earphone body B installed on the pivoting shaft base C. The earphone body B can rotate with the speaker body A via the pivoting shaft base C to be a foldable portable Bluetooth speaker 1′. The pivoting shaft base C includes a flexible printed circuit board (not labeled). The flexible printed circuit board is used for electrically connecting the speaker body A with the earphone body B.

The foldable portable Bluetooth speaker 1′ can be firmly clipped on a piece of clothing or other similar article by utilizing its foldable characteristics.

When a call is received by the Bluetooth communication device 2, a wireless signal S1 is outputted to the Bluetooth speaker 1′. After the Bluetooth speaker 1′ processes the wireless signal S1, the Bluetooth speaker 1 cooperates with the speaker unit 10 and the microphone 13 to provide a speaker communication mode in which it is unnecessary for the user to hold the receiver. Alternatively, the earphone 12 is extended and the Bluetooth speaker 1 cooperates with the microphone 13 to provide an earphone communication mode in which it is unnecessary for the user to hold the receiver.

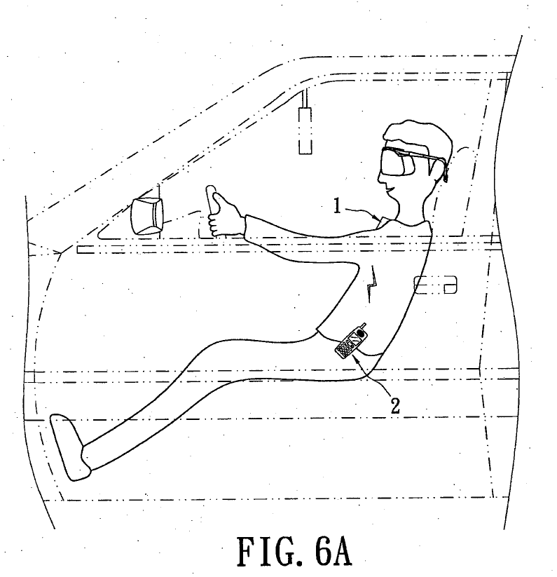

Reference is made to FIGS. 3 and 5. FIG. 5 shows a schematic diagram of the operating status of the first embodiment of the present invention. The user 3 carries the portable Bluetooth speaker 1 and the Bluetooth communication device 2 around and turns both of the devices on so as to allow the devices to communicate with each other. When a call is received by the Bluetooth communication device 2, the user 3 uses the portable Bluetooth speaker 1 to communicate in the speaker mode without holding the receiver. If the user 3 does not wish the third person to further participate in the call, the user 3 extends the earphone 12out from the interior of the portable Bluetooth speaker 1 to communicate in the earphone mode so that it is unnecessary for the user to hold the receiver. The conversation can remain private and not be overheard by a third party.

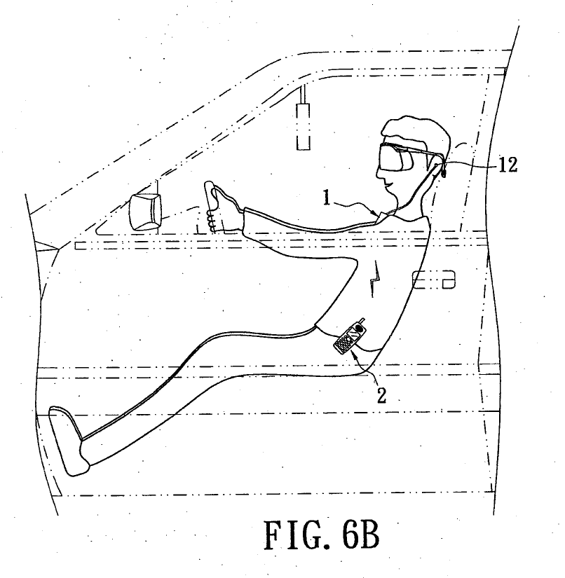

Reference is made to FIG. 6A, which shows a schematic diagram of the operating status of the second embodiment of the present invention. A user driving a vehicle wears the portable Bluetooth speaker 1. When a call is received by the Bluetooth communication device 2, the driver communicates in the speaker without holding the receiver, and a third person can participate in the call. Moreover, reference is made to FIG. 6B, which shows a schematic diagram of the operating status of the third embodiment of the present invention. The driver wears the portable Bluetooth speaker 1. When a call is received by the Bluetooth communication device 2, the driver communicates in the earphone mode without holding the receiver. The conversation can remain private and not be overheard by a third party. Therefore, the communication quality is improved.

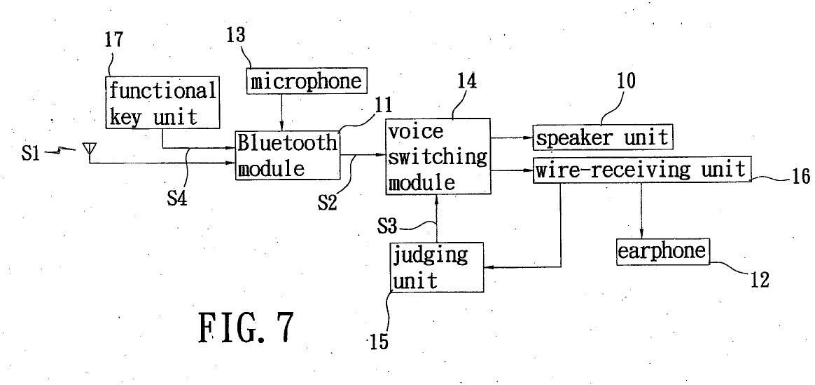

Reference is made to FIGS. 3 and 7. FIG. 7 shows a block diagram of the circuit of the present invention. The portable Bluetooth speaker 1 includes a Bluetooth module 11, a microphone 13, a voice switching module 14, a speaker 14, a wire-receiving unit 16, an earphone 12, and a judging unit 15.

The Bluetooth module 11 uses wireless communication technology to obtain a wireless signal S1 from the Bluetooth communication device 2, and processes the wireless signal S1 to output a voice signal S2. The voice switching module 14 is connected with the Bluetooth module 11 and the judging unit 15 for receiving the voice signal S2, and is controlled by the judging unit 15 to switch the transmission path for the voice signal S2. The voice switching module 14 is further connected with the speaker unit 10 and the wire-receiving unit 16. The speaker unit 10 is used for amplifying the voice signal. The wire-receiving unit 16 is connected with the earphone 12 so that the earphone 12 can be extended out from and received in wire-receiving unit 16.

The judging unit 15 outputs a high level or a low level judging signal S3 to the voice switching module 14 for switching the transmission path of the voice signal S2 according to the communication wire withdrawn or retracted. Thereby, the voice signal S2 is transmitted to the speaker unit 10 or the earphone 12. The low level judging signal S3 controls the voice switching module 14 to send the voice signal S2 to the speaker unit 10. The voice signal S2 is amplified by the speaker unit 10 and is then outputted. The speaker unit 10 cooperates with the microphone 13 connected with the Bluetooth module 11 to allow communication to take place between the user and the caller. The high level judging signal S3 controls the voice switching module 14 to send the voice signal S2 to the earphone 12. The speaker unit 10 cooperates with the microphone 13 connected with the Bluetooth module 11 to perform a private communication.

Using the high level or the low level judging signal S3 to control the transmission path of the voice signal S2 is only a first embodiment of the present invention. Other methods or devices that can achieve the same effect are within the scope of the present invention.

Reference is made to FIG. 7. The portable Bluetooth speaker 1 further includes a functional key unit 17. The functional key unit 17 is connected with the Bluetooth module 11 for providing a control instruction S4 to the Bluetooth module 11 to adjust the output volume of the speaker unit 10 or the earphone 12.

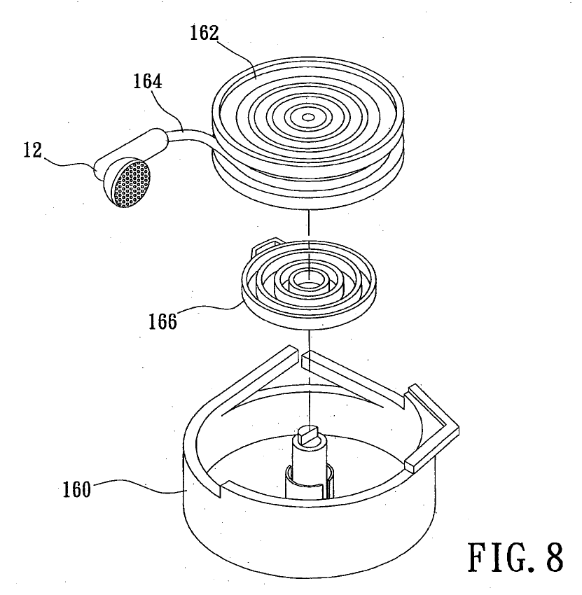

Reference is made to FIGS. 7 and 8. FIG. 8 shows a schematic diagram of the wire-receiving unit of the present invention. The wire-receiving unit 16 includes a wire slot 160, a wire-rolling disk 162, a communication wire 164, and a volute spring 166. The wire-rolling disk 162 and the volute spring 166 are pivoted in the wire slot 160. The communication wire 164 is rolled on the rotatable wire-rolling disk 162. Due to the rotation of the volute spring 166 and the volute spring 166, the communication wire 164 can be withdrawn or received. One end of the communication wire 164 is connected with the voice switching module 14, and the second end of the communication wire 164 is connected with the earphone 12.

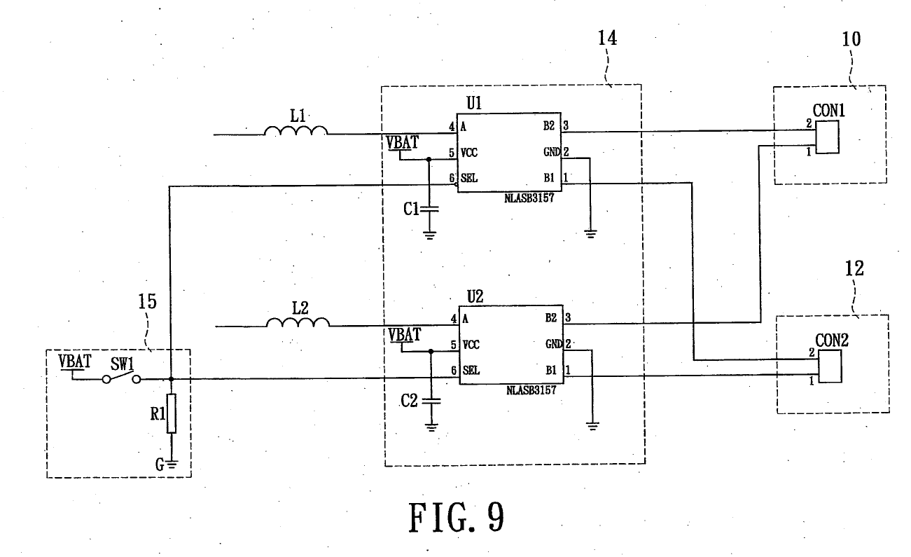

Reference is made to FIGS. 7, 8 and 9. FIG. 9 shows a schematic diagram of the circuit of the judging unit and the voice switching module of the present invention. As shown in FIG. 7, the judging unit 15 includes a hook switch SW1. One end of the hook switch SW1 is connected with a high level signal source VBAT, the second end of the hook switch SW1 is connected with a low level signal source G and the voice switching module 14 via a resistor R1. The hook switch SW1 is switched and provides a high level or a low level judging signal S3 to the voice switching module 14 for switching the transmission path of the voice signal S2 according to the communication wire 164 being extended or received.

When a call is received by the Bluetooth communication device 2, the wireless signal S1 is outputted to the Bluetooth speaker 1. After the Bluetooth speaker 1 processes the wireless signal S1, the voice signal S2 is generated and then outputted. When the user selects the speaker mode in which it is unnecessary for the user to hold the receiver, the wire-receiving unit 16 is in a completely received status and the hook switch SW1 is at OFF status. At this time, the low level signal source G provides a low level judging signal S3 and is transmitted to the voice switching module 14 via the resistor R1 to enable the control chip U1. Thereby, the voice signal S2 passes through the inductor L1, the control chip U1 and is transmitted to the speaker unit 10 to perform an amplifying operation. The control chip U1 is an NLASB3157.

When the user selects the earphone mode, the wire-receiving unit 16 is at a completely extended status and the hook switch SW1 is at ON status. At this time, the high level signal source VBAT provides a high level judging signal S3 and is transmitted to the voice switching module 14 to enable the control chip U2. Thereby, the voice signal S2 passes through the inductor L2, the control chip U2 and is transmitted to the earphone 12 to perform a private communication. The control chip U2 is NLASB3157.

The present invention uses the speaker to amplify the voice signal outputted from the Bluetooth communication device so that a number of people can hear the voice signal clearly. The voice signal is amplified, and the user does not need to hold the receiver. Furthermore, the user can pull the earphone to extend the wire which is connected with and received in the wire-receiving unit, and use the earphone to make a call. The communication is private, and the user does not need to hold the receiver.

The portable Bluetooth speaker 1 of the present invention can operate in a speaker mode in which it is unnecessary for the user to hold the receiver and in an earphone mode in which it is unnecessary for the user to hold the receiver. Therefore, the problem of the user feeling uncomfortable when the user wears the Bluetooth earphone for long periods is overcome. Furthermore, the problem of the Bluetooth earphone of the prior art only allowing one user to communicate with a caller while not allowing the third parties to participate in the call is also overcome. The communication quality is improved and it is convenient for the user.

Moreover, because multiple person communication may disclose a confidential information, the earphone that can make a private call is integrated into the portable Bluetooth speaker 1. Thereby, the communication quality is improved, and a personal call can be made. The user can determine the communication mode according to his or her requirements.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A portable Bluetooth speaker, capable of communicating wirelessly with a Bluetooth communication device, comprising:
a Bluetooth module using wireless communication technology to obtain a wireless signal from the Bluetooth communication device and output a voice signal;
a voice switching module connected with the Bluetooth module for receiving the voice signal;
a speaker connected with the voice switching module, a wire-receiving unit having a communication wire that is extended or received, wherein one end of the communication wire is connected with the voice switching module;
an earphone connected with a second end of the communication wire; and
a judging unit connected with the voice switching module and the wire-receiving unit, wherein the judging unit outputs a judging signal to the voice switching module for switching the voice signal according to the communication wire being extended or received.

2. The portable Bluetooth speaker as claimed in claim 1, further comprising a functional key, wherein the functional key is connected with the Bluetooth module for providing a control instruction to the Bluetooth module.

3. The portable Bluetooth speaker as claimed in claim 2, wherein the control instruction is used to control a volume of the speaker and the earphone.

4. The portable Bluetooth speaker as claimed in claim 1, further comprising a microphone, wherein the microphone is connected with the Bluetooth module.

5. The portable Bluetooth speaker as claimed in claim 1, further comprising a fixture.

6. The portable Bluetooth speaker as claimed in claim 1, wherein the judging unit includes a hook switch, one end of the hook switch is connected with a high level signal source, a second end of the hook switch is connected with a low level signal source and the voice switching module, and the hook switch is switched a high level or a low level judging signal is provided to the voice switching module for switching the voice signal according to the communication wire being extended or received.

7. The portable Bluetooth speaker as claimed in claim 1, wherein the wire-receiving unit further comprises a wire slot, a wire-rolling disk, and a volute spring, the wire-rolling disk and the volute spring are pivoted in the wire slot, the communication wire is rolled on the wire-rolling disk, and the communication wire is extended or received due to the volute spring.

8. A portable Bluetooth speaker, capable of communicating wirelessly with a Bluetooth communication device, comprising:
a speaker body including:
a Bluetooth module using wireless communication technology to obtain a wireless signal from the Bluetooth communication device and output a voice signal;
a voice switching module connected with the Bluetooth module for receiving the voice signal;
a speaker connected with the voice switching module,
a pivoting shaft base connected with one end of the speaker body, wherein the pivoting shaft base has a flexible printed circuit board; and
an earphone body connected with the pivoting shaft base that rotates with the speaker body, wherein the earphone body includes:
a wire-receiving unit having a communication wire that is extended or received, wherein one end of the communication wire is connected with the voice switching module via the flexible printed circuit board;
a judging unit connected with the wire-receiving unit and connected with the voice switching module via the flexible printed circuit board, wherein the judging unit outputs a judging signal to the voice switching module for switching the voice signal according to the communication wire being extended or received.

9. The portable Bluetooth speaker as claimed in claim 8, further comprising a functional key, wherein the functional key is connected with the Bluetooth module for providing a control instruction to the Bluetooth module.

10. The portable Bluetooth speaker as claimed in claim 9, wherein the control instruction is used to control a volume of the speaker and the earphone.

11. The portable Bluetooth speaker as claimed in claim 8, further comprising a microphone, wherein the microphone is connected with the Bluetooth module.

12. The portable Bluetooth speaker as claimed in claim 8, wherein the judging unit includes a hook switch, one end of the hook switch is connected with a high level signal source, a second end of the hook switch is connected with a low level signal source and the voice switching module, and the hook switch is switched a high level or a low level judging signal is provided to the voice switching module for switching the voice signal according to the communication wire being extended or received.

13. The portable Bluetooth speaker as claimed in claim 8, wherein the wire-receiving unit further comprises a wire slot, a wire-rolling disk, and a volute spring, the wire-rolling disk and the volute spring are pivoted in the wire slot, the communication wire is rolled on the wire-rolling disk, and the communication wire is extended or received due to the volute spring.
